(19) United States
(12) Patent Application Publication
(10) Pub. No.: US 2013/0002848 A1
(43) Pub. Date: Jan. 3, 2013

(54) STAGE ADAPTOR FOR IMAGING BIOLOGICAL SPECIMENS

(75) Inventors: Andries Zijlstra, Nashville, TN (US); John Lewis, London (CA)

(73) Assignee: INNOVASCREEN Inc, New Glasgow (CA)

(21) Appl. No.: 13/522,448

(22) PCT Filed: Jan. 14, 2011
(86) PCT No.: PCT/CA2011/000038

§ 371 Date: Sep. 14, 2012

Related U.S. Application Data
(60) Provisional application No. 61/295,363, filed on Jan. 15, 2010.

(51) Int. Cl. G02B 21/34; H04N 7/18

(52) U.S. Cl. 348/80; 359/398; 348/E07.085

(57) ABSTRACT

A stage adaptor for imaging a biological specimen is described. The adaptor having a housing; a vented chamber contained within the housing; and a removable lid for covering the vented chamber. A depression is provided on the removable lid for receiving an objective from a microscope. An aperture is also provided at the apex of the depression for viewing inside the vented chamber. Also described is an integrated stage adaptor and imaging system as well as a method for imaging the biological specimen using the stage adaptor.

### FIELD OF INVENTION

The invention generally relates biological imaging. More specifically, the present invention relates to a stage adaptor for imaging a biological specimens.

### BACKGROUND OF THE INVENTION

Over the past several decades the ability to achieve detailed images of biological specimens has substantially improved. The ability to capture real-time images of biological processes, such as morphogenesis in a cell, has contributed greatly to our understanding of how biological systems work and how we can alter or manipulate these processes.

Along with advances in imaging, advances have also been made in developing cell and tissue culture systems that more closely represent the in vivo condition and can be more easily studied to test different compounds and parameters. For example, the chick embryo chorioallantoic membrane (CAM) is an established model system to evaluate various in vivo parameters.

The CAM model has been used to study bacterial invasion (Adam R et al., Int J Med Microbiol., 2002, 292(3-4):267-75). This in vivo model has also been used to study angiogenesis and the effects of anti-angiogenesis agents (Richardson M et al., Current Drug Targets-Cardiovascular & Haematological Disorders, 2003, 3:155-185). Vascular changes, such as vascular leakage, can also be studied in this model (Pegaz B et al., J Photochem Photobiol B, 2005, 80(1):19-27). The CAM also serves as a good model for the study of some ocular diseases (Lange N et al., Invest Opthalmol Vis Sci., 2001, 42(1):38-46). In addition, transplantation of heterologous cells and tissues to the chick embryo is used to evaluate many different parameters of tumor growth and also to evaluate anti-neoplastic agents (Richardson M et al., supra). The natural immuno-deficiency of the chick embryo makes it a good host fora variety of cells and tissues. The CAM model system conveniently and inexpensively reproduces many of the characteristics of tumors in vivo, such as tumor mass formation, angiogenesis, infiltration and metastases.

CAMs are incubated either in ovo, or ex ovo as a shell-less culture. In both cases, the embryos must be maintained at temperature and humidity levels that are higher than those in the normal atmosphere of a lab. The embryos are preferably kept in an incubator at a temperature of about 37° C. and having approximately 60-70% humidity. These atmospheric conditions provide a hostile environment for other equipment, such as a microscope. As such, it is difficult to image the live embryos for extended periods of time and do intravital time-lapse video microscopy. It is not practical to bring an imaging device to the embryo in the incubator. Moreover, the risk of damaging a specimen by bringing the embryo to an imaging device limits its routine use. Thus, while the chick embryo CAM model has proven useful as a model for studying various biological activities such as vascularization, tumor metastases, etc, its use has been limited due to the need to carefully move chick embryos in and out of an incubator for observation.

Furthermore, imaging the CAM in ovo presents difficulties in obtaining a clear, high quality microscopic image of the specimen being studied. Although imaging the CAM ex ovo does provide a better opportunity to obtain such images, it is difficult to maintain the environmental conditions necessary to support the life of the embryo for any significant amount of time outside the incubator.

### SUMMARY OF THE INVENTION

According to an aspect of the present invention there is provided a microscope stage adaptor for imaging a biological specimen. The adaptor comprising: a housing; a vented chamber contained within the housing; and, a removable lid for covering the vented chamber. The surface of the lid in contact with the environment comprises a depression for receiving an objective from a microscope, wherein an aperture is provided at the apex of the depression for viewing inside the vented chamber.

In one embodiment, the removable lid covers only the vented chamber. In this case, a second lid may be provided that covers at least a portion of the housing.

In another embodiment, the removable lid covers the vented chamber and at least a portion of the housing.

Each of these lids can be supported by compressible posts or retractable pins. Moreover, in each of the above cases, the removable lid can be transparent.

In a further embodiment, the depression is conical in shape.

In yet a further embodiment, the aperture is covered by a cover slip.

In an alternative embodiment, a heating element for controlling the internal of the housing is provided. In some cases, the heating element wraps around the vented chamber.

In another embodiment, the adaptor further comprises at least one probe to sense environmental conditions in the housing. The probe can comprises a sensor to detect the temperature in the housing and/or a sensor to detect the humidity in the housing. The probe can also be connected to a controller that adjusts the environmental conditions in the housing in response to signals from the probe. In this case, it may be desirable to include a channel beside the housing to hold the controller.

The stage adaptor of the present invention is preferably used for imaging the chorioallantoic membrane of a developing amniote incubated in a shell-free system, wherein the amniote is a chick embryo.

According to another aspect of the present invention, there is provided an integrated stage adaptor and imaging system comprising a stage adaptor as defined hereinabove interfaced with an imaging device.

In one embodiment, the imaging device is a photomicroscope. In another embodiment, the imaging device is a video-microscope. In either case, the imaging device is adapted to process fluorescent images. The integrated system can also be interfaced with a computer program for analysis of images.

According to a further aspect of the present invention, there is provided a stage adaptor as described essentially as above having at least two vented chambers contained within the housing. Each chamber covered by a removable lid.

According to another aspect of the invention there is provided a method for imaging a biological specimen. The method comprising the steps of: transferring the biological specimen to a stage adaptor as defined hereinabove; positioning the stage adaptor in the optical axis of a microscope lens; and imaging the biological specimen through the microscope.

In one embodiment, the imaging device is a photomicroscope. In another embodiment, the imaging device is a video-microscope. In either case, the imaging device is adapted to process fluorescent images. The integrated system can also be interfaced with a computer program for analysis of images.

The stage adaptor and related systems and methods described above are preferably used for imaging the chorioallantoic membrane of a developing amniote incubated in a shell-free system, wherein the amniote is a chick embryo.

### BRIEF DESCRIPTION OF THE DRAWINGS

These and other features of the invention will become more apparent from the following description in which reference is made to the appended drawings wherein:

FIG. 1 shows a perspective view of a stage adaptor in accordance with an embodiment of the present invention;

FIG. 2 shows a top view of the embodiment of FIG. 1;

FIG. 3 shows a front view of the embodiment of FIG. 1;

FIG. 4 is a schematic representation of a stage adaptor and imaging system of the invention; and

FIG. 5 illustrates an alternative embodiment of the invention comprising multiple specimen chambers.

### DETAILED DESCRIPTION

The stage adaptor of the present invention can be used to image a number of different biological specimens. For example, the stage adaptor can be used to image living organisms, such as rodents and other laboratory animals, biopsied tissue, such a human breast tissue, and a variety cell and tissue cultures. For the purposes of the present discussion, the stage adaptor will be described with reference to its use in imaging the chorioallantoic membrane of a developing amniote incubated in a shell-free system. However, it should be readily understood that the stage adaptor could be used in a multitude of different applications.

The chorioallantoic membrane (CAM) is a vascular membrane found in the eggs of some amniotes, such as, but not limited to, chicks and quails. The present invention will be described with reference to chick embryos, since these are the most commonly studied organism for this purpose. However, the stage adaptor described herein could be used to study the CAM of other amniotes grown in a shell-less system.

The stage adaptor described herein can be used for imaging the CAM of a developing amniote incubated in a shell-less or ex ovo culture system. Auerbach et al., in Developmental Biology, 1974, 41: 391-394, the contents o which is incorporated herein, describe such an exemplary shell-less culture system. In brief, eggs are cracked on day 3 or 4 of incubation and the yolk sac placed in a Petri dish, or other suitable container. The shell-less eggs are incubated or grown in an environment with a temperature of about 37° C. with 60-70% relative humidity. After cracking, the CAM develops on the surface of the yolk sac thus permitting the whole of the organ to be available for observation of morphogenesis and growth or a response to an intervention.

The stage adaptor described herein allows for the CAM of the incubating chick embryo to imaged without having to sacrifice the chick. The stage adaptor containing the specimen, i.e. the chick embryo in a container that supports growth of the embryo, allows for real-time imaging of the CAM over a period of time or on separate occasions.

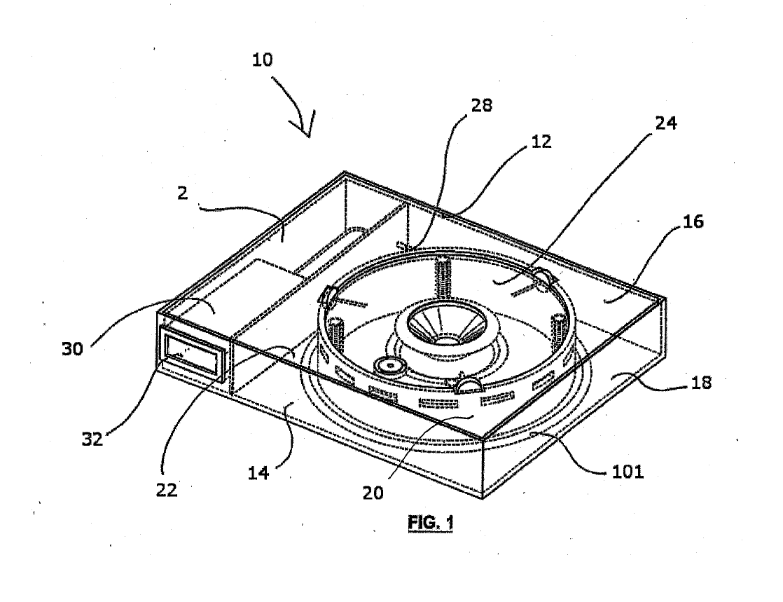

As shown in FIG. 1, the stage adaptor 10 comprises a housing 12. The housing 12 is can be defined by a front wall 14, a rear wall 16, two side walls 18, 2 and a base 22. Alternatively, the housing may be provided as a single circular wall and a base from which the wall projects from. It is preferable that the housing 12 be leak-resistant in order to retain water or other liquids necessary to maintain the life of the specimen being viewed. Within the housing 12, a vented chamber 24 for receiving a receptacle containing a chick embryo is provided. In the illustrated embodiment the housing 12 is essentially rectangular and the vented chamber 24 is shown as round. It will be apparent to a person skilled in the art that the shape of the housing and/or the vented chamber could easily be changed without affecting their function.

As shown in FIG. 3, the walls 20 of chamber 24 are vented to allow the transfer of moisture and air from inside the chamber 24 to the space 80 defined by the wall of the chamber 24 and the housing 12. The actual size and shape of the vents 50 can vary based on the specific environmental requirements of the experiment. The vents should be dimensioned to allow the humidity in the chamber 24 to be maintained at a level sufficient to support the life of the specimen being examined. It is also possible to make the vents 50 selectively closable, by including a sliding door (not shown) on all or some of the vents.

In operation, the space 80, defined by the wall of the chamber 24 and the housing 12, is at least partially filled with water, or some other equivalent liquid that can be used to maintain the humidity in the chamber 24. This space 80 can be overlaid by a covering structure 85 to minimize the amount of moisture lost to the surrounding environment. Preferably, the humidity of the chamber 24 is maintained at a level that is similar to that of the incubator, which the specimen is normally housed. The humidity is preferably maintained at about 55% to about 65% humidity, more preferably about 60% humidity.

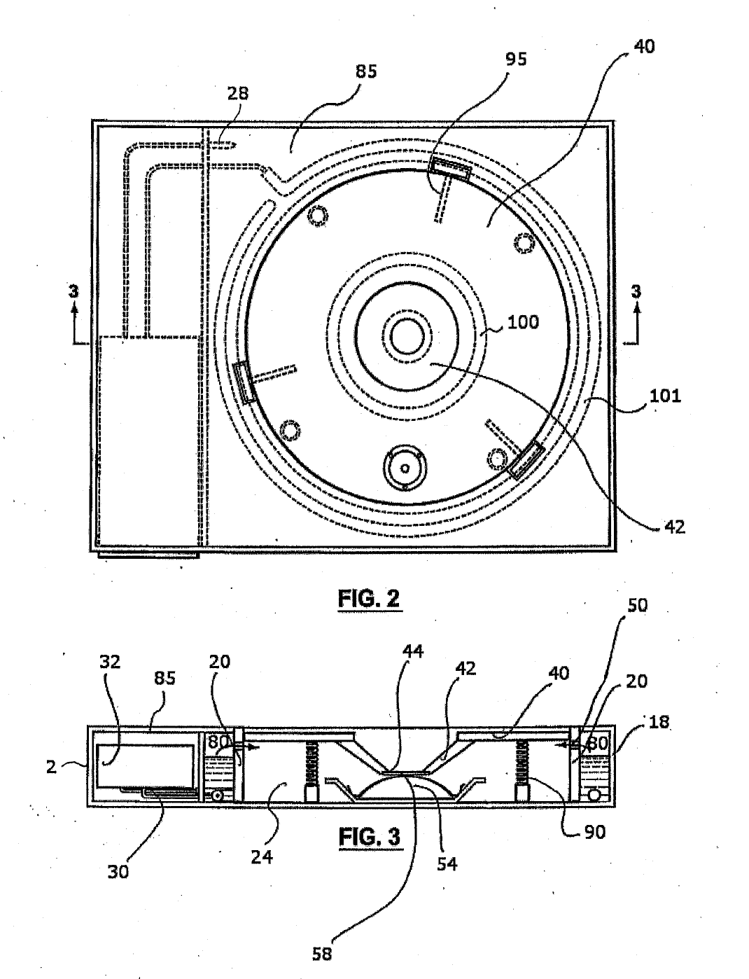

In order to maintain the humidity of the chamber 24, a lid 40 is provided, which covers the space defined by the chamber 24 (see FIG. 3). The lid 40 is removable to gain access to the inside of the chamber 24. In some instances, the lid 40 is completely removable from the housing 12 in order to gain access to the inside of the chamber 24. In other cases, the lid 40 may be hinged or slidable with respect to the housing. In situations where the lid is completely removable, the lid 40 may be simply placed on the chamber 24 to prevent crushing the specimen. In other cases, static or compressible posts 90 may be provided to support the lid 40. In conjunction with the posts 90 or separate therefrom, retractable pins 95 may be provided to support the lid 40 (FIG. 2). In this case, the lid may be provided with a collar that at least partially surrounds the chamber 24. The retractable pins 95 transverse the collar and place tension on the chamber 24 wall to hold the lid 40 in place. The size and shape of the lid 40 will in part depend upon the size and shape of the chamber 24 or the housing 12. In any case, the lid 40 should cover the space defined by the chamber 24 in order to maintain the humidity within the chamber 24.

FIG. 2 illustrates a top view of the incubator. The lid 40 is preferably transparent for easy viewing of the specimen 54 inside the chamber 24. In the illustrated embodiment, the lid 40 includes a depression 42. The depression 42 is dimensioned to receive a microscope objective. As shown in the Figures, the depression 42 is preferably conical in shape to accommodate the rotation of the different power microscope objectives mounted to the revolving nosepiece or turret of the microscope. In circumstances where a single objective microscope is used, the depression 42 may be dimensioned in a more accommodating size and shape.

As shown in FIG. 3, an aperture 44 is provided at the apex of depression 42. The aperture 44 allows viewing inside the vented chamber 24. In the case where a specimen 54 is present in the chamber 24, the aperture 44 in the depression 42 is positioned to make contact with the outermost surface of the CAM. A coverslip 58 can be either permanently or temporarily attached to the depression 42 in the vicinity of the aperture 44 to provide a barrier between the CAM and the lens of the microscope objective. The coverslip 58 can be mounted to the depression 42 by a variety of different means. For example, vacuum grease can be applied to the perimeter of the aperture 44 and the coverslip 58 temporarily attached to the depression 42. In other situations, a recess (not shown) can be provided in the depression 42 surrounding the aperture 44 and the coverslip 58 pressure fitted into place. Further still, the cover slip 58 can be placed on the upper surface of the CAM and the surface tension holds the cover slip in position. The position of the depression 42 is adjusted so that its lower surface contacts the cover slip 58 and maintains the cover slip in position on the embryo. This provides for a consistent viewing surface of a specific area of the CAM.

The temperature of the stage adaptor 10 may be maintained during operation by one of several different methods. For example, the ambient temperature of the room in which the microscope is housed can be adjusted to maintain the stage adaptor at a certain desired temperature. Moreover, the stage of the microscope may be enclosed in a temperature controlled housing. Furthermore, the ambient temperature of the housing may be maintained by including one or more heating elements within the housing. In one embodiment, a heating element 100 surrounds the specimen. Either alone or in conjunction with the heating element 100, the temperature can be maintained by a heating element 101 positioned in the water. Either heating element 100 or 101 may be associated with the base of the housing. Alternatively the heating elements 100, 101 can be associated with the lids 40, 85. The temperature is preferably maintained at between about 35° C. to about 40° C., more preferably about 37° C. to about 38° C. The temperature is preferably maintained by a thermostat-controlled, insulated heating element.

A probe 28 can be provided to sense the conditions within the vented chamber 24 or the space 80 between the wall of vented chamber 24 and the walls of the housing 12. The probe monitors the temperature and sends a signal to a heating element controller/thermostat 30 to maintain the temperature at a predetermined setting. The probe 28 may also monitor the humidity levels in the chamber 24 or the space 80.

The controller 30 may be freely attached via its wires to the stage adaptor 10. Alternatively, the stage adaptor 10 includes a receptacle for holding the controller 30 or the controller may be built into the stage adaptor housing 12. The controller 30 provides a visual display 32 of the temperature and/or humidity in the vented chamber 24.

In one embodiment, as shown in FIG. 1, the vented chamber 24 is surrounded by a heating element 101. A probe 28 monitors the temperature and/or the humidity in the space 80 between the wall of the chamber 24 and the wall of the housing 12. The heating element 101 and the probe 28 are connected to a controller 30 that can be set to predetermined settings. The controller 30 preferably includes a visual display panel 32 that indicates the conditions in the incubator. In use, the temperature is generally set at about 35 to 38° C. and the humidity is preferably in the range of about 55% to about 65%.

The stage adaptor 10 can be adapted for use as part of an integrated incubation and imaging system. The integrated system includes an imaging device interfaced with computer hardware and software for displaying and analyzing images. Various types of microscopes can be used as the imaging device. For example, the controlled environment stage adaptor may be associated with an MOT fluorescent microscope, a confocal microscope, etc. or any other upright microscope. It can be used for identification or development studies, toxicity, or any in vivo test that can be assessed using a CAM model. Proprietary computer program products and algorithms may used to display and analyze the images.

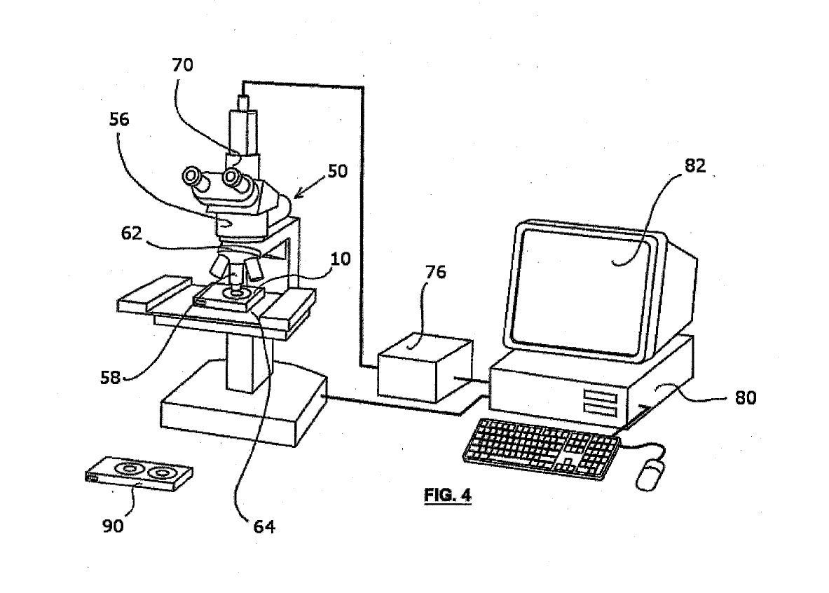

An exemplary integrated stage adaptor and imaging system according to the invention is shown in FIG. 4. In this embodiment, the stage adaptor 10 is integrated with a microscope 56. The microscope 56 includes a microscope optical system 58 and at least one microscope objective on an objective revolver or turret 62, with motorized and coded stage control 64. A video camera 70 is provided. The analog output signal from the video camera 70 is digitized with an A/D image converter 76 and temporarily stored in an image memory. The digital signal is transferred to a personal computer (PC) 80 and displayed on a monitor 82 connected to the computer 80.

A plurality of stage adaptors may be mounted on a moveable stage whereby the photomicroscope records changes on a rotating or sequential basis from one embryo to another. This enables several agents to be monitored over a specific time period. Alternatively, multiple embryo chambers can be included in a single controlled environment stage adaptor and the photomicroscope(s) can take sequential images of the embryos.

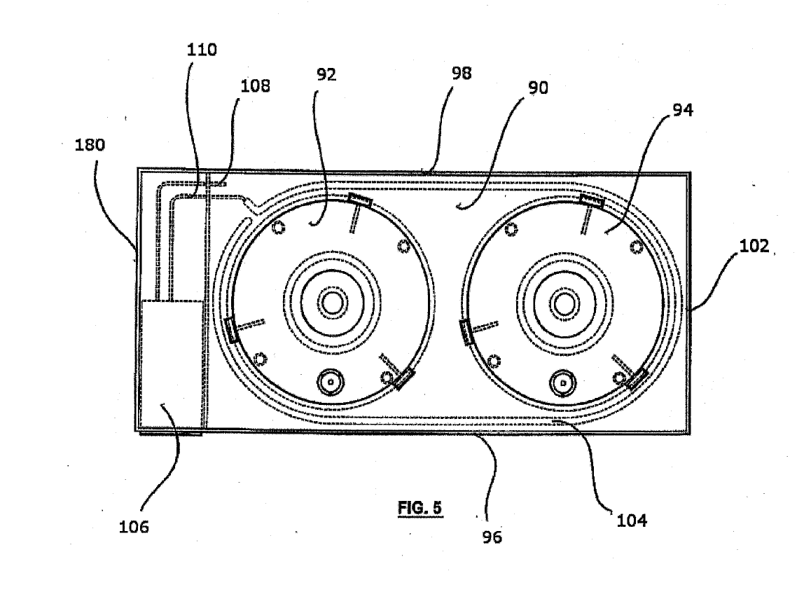

FIG. 5 illustrates an alternative embodiment of the invention. In this embodiment, the stage adaptor 90 comprises two embryo chambers 92, 94. This stage adaptor comprises a front wall 96, a rear wall 98 and two side walls 180, 102. As with the single vented chamber arrangement described above, a heating coil 104 can be provided to surround the two embryo chambers 92, 94 to control the heat. A controller module 106 can also be provided to control the heating coil 104. The controller module 106 includes a probe 108 for monitoring conditions within the stage adaptor. The controller 106 also includes an energy supply 110 for the heating coil. The use of multiple embryo chambers within a single adaptor provides for an easy comparison of two embryos by switching the imaging back and forth from one to the other. It is clearly apparent that while this embodiment illustrates two embryo chambers within a single stage adaptor, a stage adaptor comprising more than two embryo chambers is also included within the scope of the invention.

All citations are hereby incorporated by reference.

The present invention has been described with regard to one or more embodiments. However, it will be apparent to persons skilled in the art that a number of variations and modifications can be made without departing from the scope of the invention as defined in the claims.

1. A microscope stage adaptor for imaging a biological specimen; said adaptor comprising:
a housing;
a vented chamber contained within the housing; and
a removable lid for covering the vented chamber, wherein a depression is provided on the removable lid for receiving an objective from a microscope, and an aperture is provided at the apex of the depression for viewing inside the vented chamber.

2. The adaptor according to claim 1 wherein the removable lid covers only the vented chamber.

3. The adaptor according to claim 1 wherein the removable lid covers the vented chamber and at least a portion of the housing.

4. The adaptor according to claim 2 further comprising a covering structure that covers at least a portion of the housing.

5. (canceled)

6. The adaptor according to claim 1 wherein the depression is conical in shape.

7. The adaptor according to claim 1 further comprising posts or retractable pins for supporting the removable lid.

8. The adaptor according to claim 7 wherein the posts are compressible.

9. (canceled)

10. The adaptor according to claim 1 further comprising a heating element for controlling the internal temperature of the housing.

11. The adaptor according to claim 10 wherein the heating element encompasses the vented chamber.

12. The adaptor according to claim 1 further comprising at least one probe to sense environmental conditions in the housing.

13. (canceled)

14. (canceled)

15. The adaptor according to claim 12, wherein the probe comprises at least one of a sensor to detect temperature and a sensor to detect humidity.

16. The adaptor according to claim 12 wherein the probe is connected to a controller that adjusts the environmental conditions in the housing in response to signals from the probe.

17. The adaptor according to claim 16, further comprising a channel adjacent the housing to minimize movement of the controller.

18. The adaptor according to claim 17 wherein the housing and the channel are attached to a common base.

19. The adaptor according to claim 1, wherein the biological specimen is the chorioallantoic membrane of a developing amniote incubated in a shell-free system.

20. The adaptor according to claim 19, wherein the amniote is a chick embryo.

21. The adaptor according to claim 1, further comprising an interfaced imaging device.

22. The adaptor according to claim 21 wherein the imaging device is at least one of photomicroscope and video-microscope.

23. (canceled)

24. The adaptor according to claim 21 wherein the imaging device is adapted to process fluorescent images.

25. The adaptor according to claim 21 wherein the imaging device is interfaced with a computer program for analysis of images.

26. (canceled)

27. (canceled)

28. (canceled)

29. (canceled)

30. (canceled)

31. (canceled)

32. (canceled)

33. (canceled)

34. (canceled)

35. (canceled)

36. A microscope stage adaptor for imaging a biological specimen; said adaptor comprising:
a housing;
at least two vented chambers contained within the housing; and
a separate removable lid for each of the vented chambers, wherein a depression is provided on the removable lid for receiving an objective from a microscope, and an aperture is provided at the apex of the depression for viewing inside the vented chamber.

37. The adaptor according to claim 36, wherein the biological specimen is the chorioallantoic membrane of a developing amniote incubated in a shell-free system.

38. The adaptor according to claim 37, wherein the amniote is a chick embryo.

39. The adaptor according to claim 36, wherein the separate removable lids are connected to form a unified structure.
